(19) United States
(12) Patent Application Publication
(10) Pub. No.: US 2022/0269735 A1
(43) Pub. Date: Aug. 25, 2022

(54) METHODS AND SYSTEMS FOR DYNAMIC MULTI SOURCE SEARCH AND MATCH SCORING OF SOFTWARE COMPONENTS

(71) Applicant: Open Weaver Inc., Miami, FL (US)

(72) Inventors: Ashok Balasubramanian, Chennai (IN); Karthikeyan Krishnaswamy Raja, Chennai (IN); Arul Reagan S, Chengalpattu District (IN)

(73) Assignee: Open Weaver Inc., Miami, FL (US)

(21) Appl. No.: 17/678,900

(22) Filed: Feb. 23, 2022

Related U.S. Application Data
(60) Provisional application No. 63/153,196, filed on Feb. 24, 2021.

(51) Int. Cl. G06F 16/903; G06F 16/9032; G06F 16/9038; G06K 9/62; G06N 20/00

(52) U.S. Cl. CPC G06F 16/90335; G06F 16/9032; G06F 16/9038; G06K 9/6256; G06N 20/00

(57) ABSTRACT

Systems and methods for retrieving and automatically ranking software component search results are provided. An exemplary method includes parsing a search query to extract search entities, assigning each of the search entities a weight value, identifying software component sources based on the search entities, searching the software component sources for software components, retrieving software components, comparing each of the software components with each of the search entities and generating similarity scores based on each comparison, generating match scores by proportionally combining each of the similarity scores with a weight value, mapping the match scores to the software components, generating a combined match score for each of the software components by combining one or more mapped match scores associated with each of the software components, and generating a ranking of the software components based on the combined match scores.

### CROSS-REFERENCE TO RELATED PATENT APPLICATION

This application claims the benefit of and priority to U.S. Provisional Patent Application No. 63/153,196 filed Feb. 24, 2021, the entire disclosure of which is incorporated by reference herein.

### TECHNICAL FIELD

The present disclosure relates generally to development of software applications, more particularly to methods systems, and computer program product for searching, selecting, and reusing of software components for developing software applications.

### BACKGROUND

As the availability of open-source technologies, cloud-based public code repositories, and cloud-based applications increases exponentially, there is a need for software developers to efficiently find such software components for use in their software development. Today there are more than 30 million public code repositories and 100,000 public application-programming interfaces (APIs). Moreover, there are over 100 million articles that provide knowledge and review of such software components.

Today, a software developer uses a general-purpose search engine that provides a standard web search across all the instances of relevant information regarding these topics and provides separate results for each of these instances. Because of this, the software developer must spend an extensive amount of time to review these search results. The developer also must correlate and choose from different search results from diverse sources relating to the same software component. Since a typical search in a general-purpose search engine returns over 100,000 results, the developer must spend considerable amounts of time parsing through these results. Since the process of parsing through the results is manual, the developer can miss a substantial amount of information due to oversight and manual errors.

U.S. Pat. No. 9,977,656 titled “Systems and methods for providing software components for developing software applications,” by Raghottam Mannopantar, Raghavendra Hosabettu, and Anoop Unnikrishnan, filed on Mar. 20, 2017, and granted on May 22, 2018, discloses methods and systems for providing software components for developing software applications. In one embodiment, a method for providing software components for developing software applications is provided. The method comprises receiving user input requirements associated with the software application; determining a requirements matching score for every software component existing in an application development environment, based on a comparison between the received requirements and a requirements model, wherein the requirements model is generated based on historic user requirements and usage; determining a performance score based on a response time associated with the software components; determining weights corresponding to the requirements matching score and the performance score based on the requirements matching score; determining a combined score based on the determined scores and associated weights; selecting software components for developing the software application based on the determined combined scores; and providing the selected software components to the user.

U.S. Pat. No. 9,201,931 titled “Method for obtaining search suggestions from fuzzy score matching and population frequencies,” by Scott Lightner, Franz Weckesser, Rakesh Dave, and Sanjay Boddhu, filed on Dec. 2, 2014, and granted on Dec. 1, 2015, discloses method for obtaining and providing search suggestions using entity co-occurrence is disclosed. The method may be employed in any search system that may include at least one search engine, one or more databases including entity co-occurrence knowledge and trends co-occurrence knowledge. The method may extract and disambiguate entities from search queries by using an entity and trends co-occurrence knowledge in one or more database. Subsequently, a list of search suggestion may be provided by each database, then by comparing the score of each search suggestion, a new list of suggestion may be built based on the individual and/or overall score of each search suggestion. Based on the user's selection of the suggestions, the trends co-occurrence knowledgebase can be updated, providing a means of on-the-fly learning, which improves the search relevancy and accuracy.

However, the prior art documents and the conventional techniques existing at the time of the present disclosure do not teach any system or methods to simultaneously search for a software component that the software developer is looking for through developer's search query, across multiple separate sources of information, then correlate them automatically to create a combined score that provides an overall match for the software component based on the software developer's query.

Therefore, to overcome the above-mentioned disadvantages, there is a need for an improved method and a system for searching, selecting, and reusing software components that may provide an easier and more precise searching for software components with improved software quality and reduced rework.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Embodiments of the present disclosure provide systems, methods, and computer program product for searching, selecting, and reusing of software components for developing software applications. To solve the issue of finding and using software components, and make searching for software components easier and precise, the present disclosure provides systems and methods that will simultaneously search for the software component that the software developer is looking for through developer's search query, across multiple separate sources of information, then correlate them automatically to create a combined score that provides an overall match for the software component based on the software developer's query. The solution provided by the present disclosure will help the developer to save significant amount of time and select the right software component the first time, resulting in an improved software quality and reduced rework.

In one embodiment, a system for Dynamic Multi Source Search and Match Scoring of Software Components is provided. The system comprises: at least one processor that operates under control of a stored program comprising a sequence of program instructions to control one or more components, wherein the components comprising: a Web GUI portal to submit search query of a user and view search results; a Query Splitter to parse the search query to extract search entities; a Dynamic Field Weight Assigner to assign scores or weights to the search entities for indicating the significance of search entities in the user search query; a Multi Search Assigner to assign the search of search entities to different search services; a Repository Name Search Service to search software components against their repository names; a Source Code Search Service to search software components against their source code and associated artefacts; a Description Text Search Service to search software components against their Description Text; a Readme Files Search Service to search software components against their Readme Files; an Installation Guide Search Service to search software components against their Installation Guides; a User Guide Search Service to search software components against their User Guides; a Search Source Processor to process different software component details that are available in public to be stored for individual search identifier searches; and a Combined Match Score generator to compute a combined match score for a software component.

In another embodiment, a method for Dynamic Multi Source Search and Match Scoring of Software Components is provided. The method comprising the steps of: providing at least one processor that operates under control of a stored program comprising a sequence of program instructions comprising: reading an input software component search query and splitting the search query to identify search entities; assigning dynamic weights to the search entities for indicating the significance of search entities in the user search query; assigning different search entities to different search service; searching for a software component based only on its repository name; searching for a software component based only on its source code; searching for a software component based only on its description text; searching for a software component based only on its Readme files; searching for a software component based only on its Installation guide; searching for a software component based only on its user guide; providing a combined match score for the software component based on the weights and individual search entity similarity scores; and importing and processing software component artefacts from public repositories.

In yet another embodiment, a computer program product for Dynamic Multi Source Search and Match Scoring of Software Components is provided. The computer program product comprises: a processor; and a memory for storing instructions; wherein the instructions when executed by the processor causes the processor to: read an input software component search query and splitting the search query to identify search entities; assign dynamic weights to the search entities for indicating the significance of search entities in the user search query; assign different search entities to different search service; search for a software component based only on its repository name; search for a software component based only on its source code; search for a software component based only on its description text; search for a software component based only on its Readme files; search for a software component based only on its Installation guide; search for a software component based only on its user guide; provide a combined match score for the software component based on the weights and individual search entity similarity scores; and import and process software component artefacts from public repositories.

The details of one or more implementations of the subject matter described in this specification are set forth in the accompanying drawings and the description below. Other features, aspects, and advantages of the subject matter will become apparent from the description, the drawings, and the claims.

One implementation of the present disclosure is a system for retrieving and automatically ranking software component search results. The system includes one or more processors and memory storing instructions that, when executed by the one or more processors, cause the one or more processors to perform operations. The operations include parsing a search query to extract a number of search entities, assigning each of the number of search entities a weight value, identifying a number of software component sources based on the search entities, searching the software component sources for a number of software components, retrieving a number of software components, comparing each of the number of software components with each of the number of search entities and generating a number of similarity scores based on each comparison, generating a number of match scores by proportionally combining each of the number of similarity scores with a weight value, mapping the number of match scores to the number of software components, generating a combined match score for each of the software components by combining one or more mapped match scores associated with each of the number of software components, and generating a ranking of the software components based on the combined match scores.

In some embodiments, the number of software component sources includes at least one of repository name files, source code files, description text files, ReadMe files, installation guide files, or user guide files.

In some embodiments the operations further include accepting a remote location of the search query via a first web GUI portal that allows a user to upload a request comprising the search query.

In some embodiments, the operations include compiling a software data set, extracting software category data, preparing training data from the software category data, and training a machine learning model via the training data to identify the number of one or more software component sources based on the search entities.

In some embodiments, the operations include providing each search entity to a search system of a number of search systems, each search system individually configured to access and search one of the number of software component sources. Retrieving the number of software components includes receiving the number of software components from the number of search systems.

In some embodiments, each of the number of search systems utilizes a separate machine-learning model, the separate machine learning model trained via training data specific to a software category source.

In some embodiments, assigning each of the number of search entities a weight value includes compiling a number of previous search queries, extracting data by reading the previous search queries for keywords and semantic linguistics, preparing training data based on the extracted data, training a machine-learning model via the training data to infer a relative level of importance associated with an intent of the search query user for each of the search entities, and applying the machine-learning model to the number of search entities to determine a relative weight value for each of the number of search entities.

In some embodiments, the operations further include identifying a threshold weighted value score and discarding one or more search entities assigned a weighted value less than the threshold weighted value from the number of search entities, prior to identifying the number of software component sources based on the search entities.

Another implementation of the present disclosure is a method for retrieving and automatically ranking software component search results. The method includes parsing a search query to extract a number of search entities, assigning each of the number of search entities a weight value, identifying a number of software component sources based on the search entities, searching the software component sources for a number of software components, retrieving a number of software components, comparing each of the number of software components with each of the number of search entities and generating a number of similarity scores based on each comparison, generating a number of match scores by proportionally combining each of the number of similarity scores with a weight value, mapping the number of match scores to the number of software components, generating a combined match score for each of the software components by combining one or more mapped match scores associated with each of the number of software components, and generating a ranking of the software components based on the combined match scores.

In some embodiments, the number of software component sources comprises at least one of repository name files, source code files, description text files, ReadMe files, installation guide files, or user guide files.

In some embodiments, the method includes accepting a remote location of the search query via a web GUI portal that allows a user to upload a request comprising the search query.

In some embodiments, the method includes compiling a software data set by searching public software sources, extracting software category data, preparing training data from the software category data, and training a machine learning model via the training data to identify the number of one or more software component sources based on the search entities.

In some embodiments, the method includes providing each search entity to a search system of a number of search systems, each search system individually configured to access and search one of the number of software component sources, wherein retrieving the number of software components includes receiving the number of software components from the number of search systems.

In some embodiments, each of the number of search systems utilizes a separate machine-learning model, the separate machine learning model trained via training data specific to a software category source.

In some embodiment, assigning each of the number of search entities a weight value includes compiling a number of previous search queries, extracting data by reading the previous search queries for keywords and semantic linguistics, preparing training data based on the extracted data, training a machine-learning model via the training data to infer a relative level of importance associated with an intent of the search query user for each of the search entities, and applying the machine-learning model to the number of search entities to determine a relative weight value for each of the number of search entities.

In some embodiments, the method includes identifying a threshold weighted value score and discarding one or more search entities assigned a weighted value less than the threshold weighted value from the number of search entities, prior to identifying the number of software component sources based on the search entities.

Another implementation of the present disclosure relates to a computer program product for retrieving and automatically ranking software component search results. The computer program product includes a processor and memory storing instructions thereon. The instructions when executed by the processor cause the processor to parse a search query to extract a number of search entities, assign each of the number of search entities a weight value, identify a number of software component sources based on the search entities, search the software component sources for a number of software components, retrieve a number of software components, compare each of the number of software components with each of the number of search entities and generate a number of similarity scores based on each comparison, generate a number of match scores by proportionally combining each of the number of similarity scores with a weight value, map the number of match scores to the number of software components, generate a combined match score for each of the software components by combining the one or more mapped match scores associated with each of the number of software components, and generate a ranking of the software components based on the combined match scores.

In some embodiments, the instructions further cause the processor to compile a software data set by searching public software sources, extract software category data, prepare training data from the software category data, and train a machine learning model via the training data to identify the number of one or more software component sources based on the search entities;

In some embodiments, the instructions further cause the processor to provide each search entity to a search system of a number of search systems, each search system individually configured to access and search one of the number of software component sources. Retrieving the number of software components includes receiving the number of software components from the number of search systems, wherein each of the number of search systems utilizes a separate machine-learning model, the separate machine learning model trained via training data specific to a software category source.

In some embodiments, assigning each of the number of search entities a weight value includes compiling a number of previous search queries, extracting data by reading the previous search queries for keywords and semantic linguistics, preparing training data based on the extracted data, training a machine-learning model via the training data to infer a relative level of importance associated with an intent of the search query user for each of the search entities, and applying the machine-learning model to the number of search entities to determine a relative weight value for each of the number of search entities.

### BRIEF DESCRIPTION OF THE DRAWINGS

The invention can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows an exemplary system architecture that performs dynamic multi source search and match scoring of software components, according to some embodiments.

FIG. 2 shows an example computer system implementation for dynamic multi source search and match scoring of software components, according to some embodiments.

FIG. 3 shows the overall process flow for dynamic multi source search and match scoring of software components, according to some embodiments.

FIG. 4 shows an exemplary implementation of query extractor for dynamic multi source search and match scoring of software components, according to some embodiments.

FIG. 5 shows the process flow of assigning weights to entities for dynamic multi source search and match scoring of software components, according to some embodiments.

FIG. 6 shows an exemplary implementation of intent classifier to route entities for dynamic multi source search and match scoring of software components, according to some embodiments.

Like reference numbers and designations in the various drawings indicate like elements.

### DETAILED DESCRIPTION

Various aspects of the systems, apparatuses, and methods are described more fully hereinafter with reference to the accompanying drawings. The teachings of the present disclosure may, however, be embodied in many different forms and should not be construed as limited to any specific structure or function presented throughout the present disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the systems, apparatuses, and methods disclosed herein, whether implemented independently or combined with any other aspect of the disclosure. In addition, the scope is intended to cover such a system or method which is practiced using other structure and functionality as set forth herein. It should be understood that any aspect disclosed herein may be embodied by one or more elements of a claim.

The word “exemplary” is used herein to mean “serving as an example, instance, or illustration.” Any implementation described herein as “exemplary” is not necessarily to be construed as preferred or advantageous over other implementations. The following description is presented to enable any person skilled in the art to make and use the embodiments described herein. Details are set forth in the following description for purpose of explanation. It should be appreciated that one of ordinary skill in the art would realize that the embodiments may be practiced without the use of these specific details. In other instances, well known structures and processes are not elaborated in order not to obscure the description of the disclosed embodiments with unnecessary details. Thus, the present application is not intended to be limited by the implementations shown, but is to be accorded with the widest scope consistent with the principles and features disclosed herein.

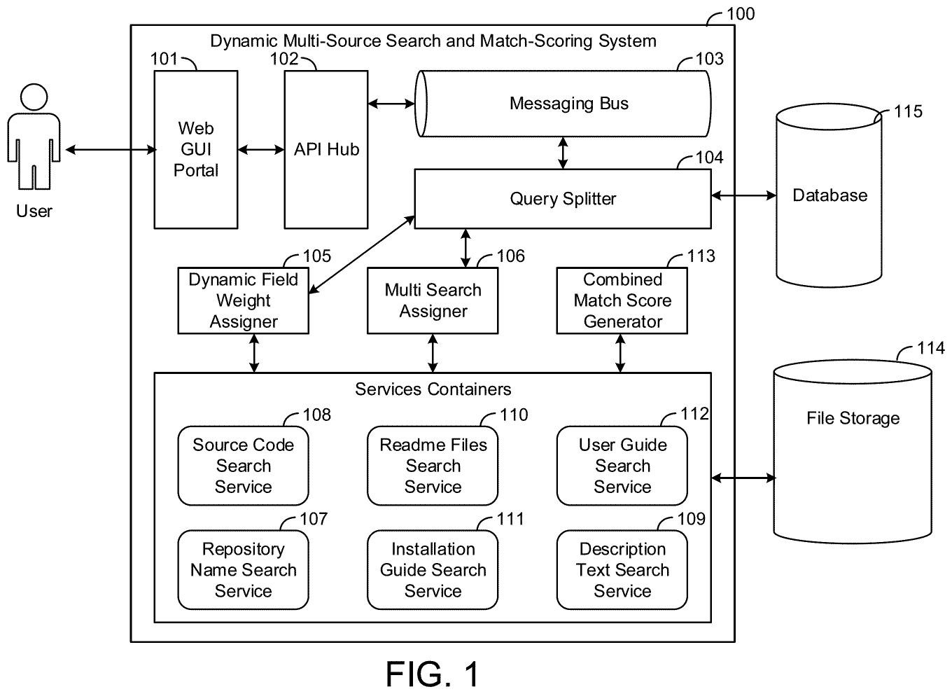

FIG. 1 shows a system 100 that performs dynamic multi-source search and match-scoring of software components. Briefly, and as described in further detail below, system 100 includes a Web Graphical User Interface (GUI) Portal 101, API Hub 102, Messaging Bus 103, Query Splitter 104, Dynamic Field Weight Assigner 105, Multi Search Assigner 106, Repository Name Search Service 107, Source Code Search Service 108, Description Text Search Service 109, Readme Files Search Service 110, Installation Guide Search Service 111, User Guide Search Service 112, Combined Match Score generator 113, File Storage 114, Database 115 and Search Source Processor 116, which are a unique set of components to perform the task of dynamic multi-source search and match-scoring of software components based on a user search query. In the embodiment shown in FIG. 1, the Web GUI Portal 101 of the system 100 has a User Interface form for a user to interface with the system 100 for submitting different requests and viewing their status. The Web GUI Portal 101 allows the user to submit requests for searching software components and viewing the generated results (e.g., the user search query). For submitting a new request, a user is presented with a form to provide one or more user input queries. After entering these details, the system 100 validates the provided information and presents an option to submit the request. After system 100 processes the search, the user can access the results from the status screen.

The submitted request from Web GUI Portal 101 goes to the API Hub 102, which acts as a gateway for accepting and transmitting all web service requests from the Web GUI Portal 101. The API Hub 102 hosts the web services for taking the requests and creating request messages to be put into the Messaging Bus 103. The Messaging Bus 103 provides for event driven architecture, thereby enabling long running processes to be decoupled from requesting calls from the system 100. This decoupling may help the system 100 to service the request and notify user once the entire process of searching the software component is completed. In some embodiments, system 100 may include job listeners configured to listen to the messages in the Messaging Bus 103. The Query Splitter 104 splits the user input queries into multiple search entities by applying machine learning models. The Query Splitter 104 recognizes various categories across software technologies including, but not limited to, Software Name, Programming Language, Frameworks, Functionality Requirements, and secondary requirements including, but not limited to, troubleshooting, installation, and usage guides.

The Dynamic Field Weight Assigner 105 assigns weights to the different search entities obtained by the Query Splitter 104 by applying the machine learning models. Based on the priority of each of the entities recognized by the machine learning models, a fractional score between 0 and 1 (e.g., a weight) is assigned to each entity, signifying their importance to the user in their search query. The Multi Search Assigner 106 then identifies each search entity that has been assigned a fractional score greater than 0 and assigns it to the respective search module.

In some embodiments, the Repository Name Search Service 107 searches for the search entity assigned against all software repository names available and returns a score (e.g., a search entity similarity score) indicating a percentage similarity match. The Repository Name Search Service 107 uses a combination of Fuzzy Keyword Search for shorter entities of 2 words or less and a sematic search for entities with 3 words or longer. Semantics of the sentence can be identified by parts of the speech that interpret a meaning to a sentence. The specific search here is done for 3 words or longer.

In some embodiments, the Source Code Search Service 108 searches for the search entity assigned against all software source code available and returns a score indicating a percentage similarity match. The Source Code Search Service 108 uses a combination of natural language search for code documentation such as inline comments, class comments, function comments, and code metadata such as function names, class names, import statements, variables and source repository metadata such programming language to search the code.

In some embodiments, the Description Text Search Service 109 searches for the search entity assigned against all software descriptions available and returns a score indicating a percentage similarity match. The Description Text Search Service 109 uses a combination of Fuzzy Keyword Search for shorter entities of 2 words or less and a sematic search for entities with 3 words or longer. The Readme Files Search Service 110 searches for the search entity assigned against all software Readme files available and returns a score indicating a percentage similarity match. The Readme Files Search Service 110 uses a combination of fuzzy, keyword search for shorter entities of 2 words or lesser and a sematic search for entities with 3 words or longer. The Installation Guide Search Service 111 searches for the search entity assigned against all software Installation Guide files available and returns a score indicating a percentage similarity match. The Installation Guide Search Service 111 uses a combination of Fuzzy Keyword Search for shorter entities of 2 words or less and a sematic search for entities with 3 words or longer. The User Guide Search Service 112 searches for the search entity assigned against all software User Guide files available and returns a score indicating a percentage similarity match. The User Guide Search Service 112 uses a combination of Fuzzy Keyword Search for shorter entities of 2 words or less and a sematic search for entities with 3 words or longer.

The Combined Match Score generator 113 then processes the individual search entity similarity scores from Repository Name Search Service 107, Source Code Search Service 108, Description Text Search Service 109, Readme Files Search Service 110, Installation Guide Search Service 111, User Guide Search Service 112, and the search entity weights from Dynamic Field Weight Assigner 105 and computes an overall Combined Match Score for that software component against the user search query and sends it back to the user.

The File Storage 114 is used to store document type of data, source code files, documents, readme files, installation guides, user guides, neural network models etc. The File Storage 114 includes a Repository Name Data Source 116.

The Database 115 is a Relational Database Management System (RDBMS) (e.g., My SQL) to store all meta-data pertaining to the requests received from the user portal, messaging bus, request processor and from other system components described above. The meta-data includes details of every request to identify the user who submitted it, requested project or source code details to track the progress as the System processes the request through its different tasks. The status of each execution step in the entire process is stored in this database to track and notify user on completion.

In some embodiments, the Search Source Processor 116 processes different software component details that are available in public code repositories including, but not limiting to, GitHub, GitLab, Bitbucket, SourceForge; Cloud and API providers including, but not limiting to, Microsoft Azure, Amazon Web Services, Google Compute Platform, RapidAPI; software package managers including, but not limiting to, NPM, PyPi etc.; public websites including, but not limiting to, the product details page of the software component provider, Wikipedia, etc.; and stores the details into the file storage as Repository Name, Source Code, Description Text, Readme Files, Installation Guide, and User Guide along with a unique identifier for the software component.

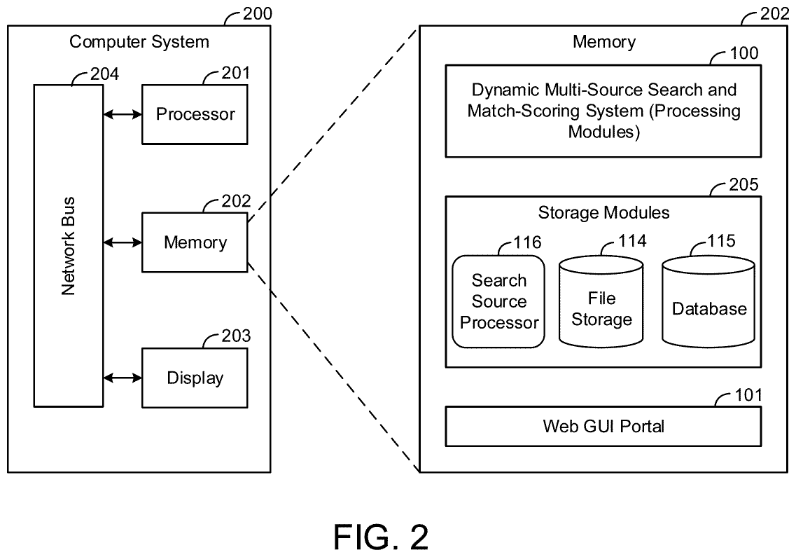

FIG. 2 shows a block view of the computer system implementation 200 in an embodiment performing Dynamic Multi Source Search and Match Scoring, according to some embodiments. This may include a Processor 201, Memory 202, Display 203, Network Bus 204, and other input/output like a mic, speaker, wireless card etc. The System 100, including the File Storage 114, Database 115, Search Source Processor 116, and Web GUI portal 101 are stored in the Memory 202 which provides the necessary machine instructions to the processor 201 to perform the executions for the System 100. In some embodiments, the Processor 201 controls the overall operation of the system and managing the communication between the components through the Network Bus 204. The Memory 202 holds the code, data, and instructions of the System 100 and of diverse types of the non-volatile memory and volatile memory. In some embodiments, the Processor 201 and the Memory 202 form a processing circuit to perform the various functions and processes described throughout the present disclosure.

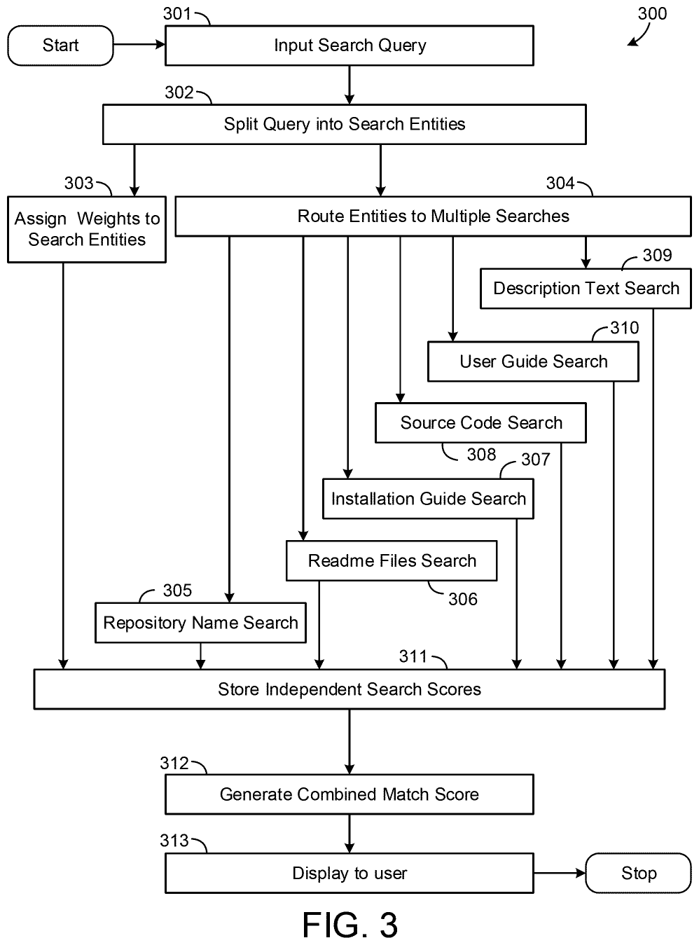

Referring now to FIG. 3, shows a process 300 for Dynamic Multi-Source Search and Match Scoring is shown, according to some embodiments. The process 300 may involve one or more components included in the system 100 depicted in FIG. 1. In step 301, the user enters a search query for which the user intends to select a software component against. In step 302, the search entities are extracted by splitting the search query. The step 302 may be performed by the Query Splitter 104.

Following step 302, the process 300 splits into two branches. The first branch proceeds with step 303. In step 303, weighted scores are assigned to the search entities. The step 303 may be performed by the Dynamic Field Weight Assigner 105. The second branch proceeds with step 304. In step 304, each search entity with a non-zero weighted score is assigned to the respective searches. The step 304 may be performed by the Multi-Search Assigner 106.

Following step 304, process 300 splits the second branch into five additional branches, according to some embodiments. The third branch (e.g., the first branch following step 304) proceeds with step 305. In step 305, a search similarity match is provided against a repository name. The step 305 may be performed by the Repository Name Search Service 107. The fourth branch (e.g., the second branch following step 304) proceeds with step 306. In step 306, a search similarity score is provided against Readme files. The step 306 may be performed by the Readme Files Search Service 110. The fifth branch (e.g., the third branch following step 304) proceeds with step 307. In step 307, a search similarity score is provided against an Installation Guide. The step 307 may be performed by the Installation Guide Search Service 111. The sixth branch (e.g., the fourth branch following step 304) proceeds with step 308. In step 308, a search similarity score is provided against source code and associated artefacts of source code. The step 308 may be performed by the Source Code Search Service 108. The seventh branch (e.g., the fifth branch following step 304) proceeds with step 309. In step 309, a search similarity score is provided against description text. The step 309 may be performed by the Description Text Search Service 109. The eighth branch (e.g., the sixth branch following step 304) proceeds with step 310. In step 310, a search similarity score is provided against the User Guide. The step 310 may be performed by the User Guide Search Service 112. In some embodiments, steps 305, 306, 307, 308, 309, and 310 may be processed in parallel.

Following steps 305, 306, 307, 308, 309, and 310, process 300 merges the third, fourth, fifth, and sixth branches at step 311. In step, 311 the search entity similarity scores from the previous steps 305, 306, 307, 308, 309, and 310 are temporarily stored to transmit it to the next step. The search entity similarity scores may be temporarily stored in the Memory 202.

Following step 311, process 300 merges the first and second branches at step 312. In step 312, the scores temporarily stored in step 311 are retrieved from the Memory 202. The weights assigned to search entities assigned in step 303 are correlated with the search entity similarity scores to generate the combined match score. The step 312 may be performed by the Combined Match Score Generator 113. In step 313, the multi-source search result and match score are made available to the user on the portal.

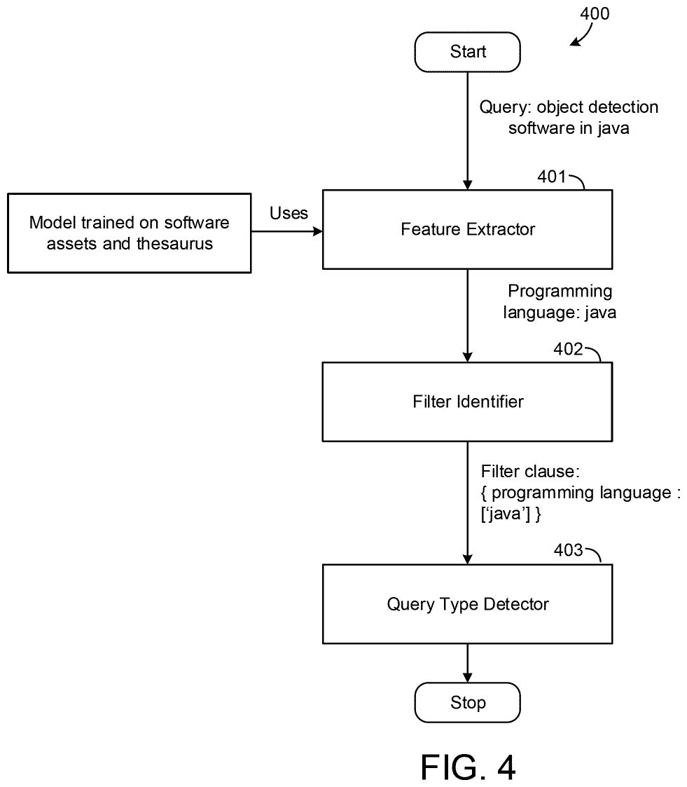

FIG. 4 shows a process 400 for implementing the Query Splitter 104 to split the user input queries into search entities for Dynamic Multi-Source Search and Match-Scoring. For example, the process 400 may be the step 302 described in relation to FIG. 3. The process 400 may be initiated by receiving a search query. For example, as described in regards to the step 301 depicted in FIG. 3, the user may enter a search query for which the user intends to select a software component against. The search query is received by the Query Splitter 104. In step 401, software entities are identified and extracted from the search query. Step 104 may be completed by a Feature Extractor included in the Query Splitter 104. Software entities such as programming language, software license, source type (e.g., github, gitlab, etc.) may be identified from the search query using entity extraction machine learning techniques. For example, an entity extraction machine learning model may be trained on a software dataset (e.g description, readme, source code) collected from different public sources (e.g., github, gitlab, etc.) to form a technology entity list including a number of technology entities. For example if a search query “connecting to mysql using spring boot” is passed to the Feature Extractor, the Feature Extractor will produce the following sample json output:

```
{
  “search_query” : “connecting to mysql using spring boot”
  “technology_entity” : [“mysql”,“spring boot”]
}
```

In some embodiments, in step 402, a filter entity may be identified if it is present in the search query. Step 402 may be completed by a Filter Identifier. The Step Filter Identifier may use a machine learning-based technique to identify the filter entities from the search query. To build the machine learning model for the machine-based learning technique, specific sets of software search queries from a history of search queries with filter components in the search queries may be picked and used to train model. If a filter entity is present in the technology entity then the technology entity will be removed from the technology entity list. For the sample search query “connecting to mysql using spring boot”, the Filter Identifier will produce the following sample json output. Here the entity “spring boot” which is identified as filter entity has been removed from technology entity list.

```
{
  “search_query” : “connecting to mysql using spring boot”,
  “technology_entity” : [“mysql”],
  “filter_entity” : [“spring boot”]
}
```

In step 403 the type of search query is identified. The step 403 may be completed by a Step Query Type Detector. Query Type Detector may rank the search query across three types of categories such semantic, keyword, code. Each of the categories maybe assigned a weight. In some embodiments, the weight may be a medium weight, a low weight, or a higher weight. If the search query has 1 or 2 words then it will be placed under “keyword” category and a respective weight will be assigned to keyword category. If the search query has 3 or more words then it will be evaluated against a “semantic” logic. The semantic logic will use Natural Language Processing techniques including, but not limited to, speech tagging retrieval, named entity recognition, etc., and will identify if the passed-in search query is identified as semantic. The semantic logic may generate a confidence score associated with the search query. If the confidence score of the semantic logic is less than a threshold then the query type of the search query will be identified as “keyword” category. If the query type is identified as “keyword,” then a higher weight (w1) will be assigned to the “keyword” category followed by a medium weight (w2) for the “semantic” category. If the query type is identified as “semantic” then a higher weight (w1) will be assigned to the “semantic” category followed by a medium weight (w2) for “keyword” category. For example, for a search query “connecting to mysql using spring boot”, Query Type Detector will produce the following json output.

```
{
  “search_query” : “connecting to mysql using spring boot”,
  “technology_entity” : [“mysql”],
  “filter_entity” : [“spring boot”],
  “query_type_ranking” : [{“type”:“keyword”, “weight”: 0.9},
  {“type”:“semantic”, “weight”: 0.6}]
}
```

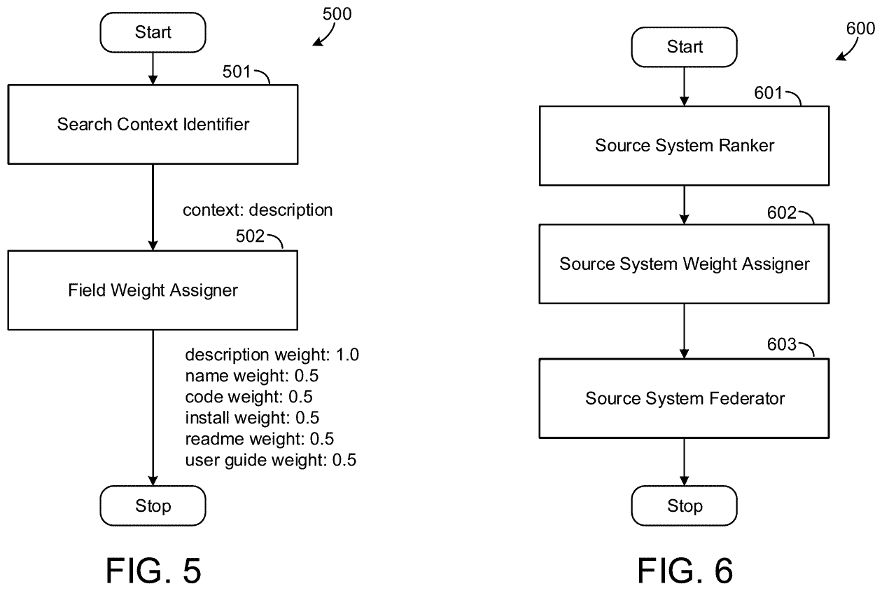

FIG. 5 shows an exemplary implementation of the step 303 of flow 300 (e.g., assigning weights to entities), according to some embodiments. In step 501, the context of a search query may be identified from the software search source. The step 501 may be completed by a Search Context Identifier. The Search Context Identifier may identify one contexts from the six contexts including description, name, code, install, readme, and user guide. The Search Context Identifier may be trained on a classification-based machine learning algorithm which uses specific datasets from the software search query historical data as well as user-labelled (e.g., manually labeled) query data. Search Context Identifier will classify the passed query into any one of the six categories based on a probability threshold configured by the machine learning model. For example for the search query “connecting to mysql using spring boot,” the Search Context Identifier may set the json output as below

```
{
  “query” : “connecting to mysql using spring boot”,
  “context” : “description”
}
```

In step 502, weights may be assigned to the context which was identified in the step 501 by the Search Context Identifier, according to some embodiments. Step 502 may be completed by a Field Weight Assigner. Field Weight Assigner may assign a weight of 1.0 for a context which was identified in step 501. For the other categories which were not identified in step 501, a default value of 0.5 may be assigned. For example for search query “connecting to mysql using spring boot,” sample json output is provided below.

```
{
  “query” : “connecting to mysql using spring boot”,
  “description_weight” : 1.0,
  “name_weight” : 0.5,
  “code_weight” : 0.5,
  “install_weight” : 0.5,
  “readme_weight” : 0.5,
  “user_guide_weight” : 0.5
}
```

FIG. 6 shows an exemplary implementation of step 304 of flow 300 (e.g., routing entities to multiple searches), according to some embodiments. In step 601, an input may be received from the Search Query Splitter, described in further detail in regards to step 302 of flow 300. Step 601 may be completed by a Source System Ranker. The Source System Ranker may rank the source systems based a ranking-based machine learning algorithm. For the machine-learning algorithm, training data may be prepared from specific set of historical software search query dataset as well as a human annotated dataset. The Source System Ranker, using the ranking machine learning algorithm, may rank the source systems based on the intent of the search query. Only the sources which are above a set threshold limit will be listed in the output. For example, for a search query “connecting to mysql using spring boot”, sample json output is provided below. As shown, based on the query intent, 3 sources such as user guide, readme, and description are listed in the output.

```
{
  “query” : “connecting to mysql using spring boot”,
  “technology_entity” : [“mysql”],
  “filter_entity” : [“spring boot”],
  “query_type_ranking” : [{“type”:“keyword”, “weight”: 0.9},
  {“type”:“semantic”, “weight”: 0.6}, {“type”:“code”, “weight”:
  0}],
  “source_ranking” : [“user guide”, “readme”, “description”]
}
```

In step 602, weights may be assigned to source systems that were ranked in step 601. Weights may be assigned by a Source System Weight Assigner. For example, for search query “connecting to mysql using spring boot”, a sample json output is provided below.

```
{
      “query” : “connecting to mysql using spring boot”,
      “technology_entity” : [″mysql”],
      “filter_entity” : [″spring boot”],
      “query_type_ranking” : [{″type”:”keyword”, “weight”: 0.9},
      {″type”:”semantic”, “weight”: 0.6}, {″type”:”code”, “weight”:
      0}],
      “source_ranking” : [“user guide”, “readme”, “description”],
      “source_ranking_weights” : [{“source” : “user guide”, “weight”:
      0.9}, {″source” : “readme”, “weight”: 0.7}, {″source”:
      “description”, “weight” : 0.5}]
}
```

In step 603, a request may be made to the downstream source systems services such as the Repository Name Search described in regards to step 305, the Readme Files Search described in regards to step 306, the Installation Guide Search described in regards to 307, the Source Code Search described in regards to step 308, the Description Text Search described in regards to step 309, and the User Guide Search described in regards to 310, according to some embodiments. The request may be made by a Source System Federator. Source System Federator may make a parallel request to all the source systems as suggested in regards to step 602. Source System Federator may also help to build target source specific queries along with the weights such as a Query Type Weight from the Query Type Detector described in regards to step 403 of FIG. 4 and source ranking weights from the Source System Weight Assigner described in regards to step 602. Weights passed to the target source systems will be used for sorting and ranking of the search results. For example, if the Query Type Detector 403 suggests two categories such as “keyword” and “semantic” with its corresponding weights, then the Source System Federator will form a keyword-based query and semantic-based query along with its corresponding weights. If the Source System Weight Assigner suggests three sources such as “user guide,” “readme,” and “description,” then a keyword and semantic search request will be made with the weights of keyword and semantic as received from step 403 in all three sources in parallel.

In this sense, the System 100 may aid in narrowing down the downstream source system search process based on a user's software need. The combined score may be used in the ranking of the software components. The combined score may be passed to a software ranking module to correctly rank the software components result for the user. The combined score along with the additional details from user profile information also helps to recommend right software components based on user behavior with respect to selecting software components based on its multiple attributes such as programming language, license, domain, taxonomy, etc.

Referring again to FIG. 3 (and with additional reference to FIGS. 1 and 4), the various steps include in the process 300 are described in greater detail. In some embodiments, in step 305, a search similarity match is provided against a repository name which will be retrieved from sources such as Github, Gitlab, etc. The Repository Name Search Service 107 may accept both semantic types of queries as well as keyword types of queries based on the output of a Query type detector 403. If the query is of semantic type, a semantic weight (W_{semantic}) from step 304 will be multiplied by the weight of source system (W_{source}) determined in step 304 and is further multiplied by the similarity score of match against repository names for each record in a Repository Name Data Source stored in the File Storage 114. Similarly if the query is for a keyword, keyword weight (W_{keyword}) from step 304 will be multiplied by the weight of source system (W_{source}) determined in step 304 and is further multiplied by the similarity score (Sₛᵢₘ) of match against a repository name for each record in the Repository Name Data Source. For example, if SN_{semantic} denotes a semantic search score for a repository name match in the data source, the calculation will be:

SN_{semantic}=W_{semantic}×W_{source}×Sₛᵢₘ

If SN_{keyword} denotes a keyword search score for a repository name match in the data source, the calculation will be:

SN_{keyword}=W_{keyword}×W_{source}×Sₛᵢₘ

The output from the Repository Name Search for semantic query type will look like:

```
{
      “name_match_ list_semantic” : [{“name”: “repo1”, “score” :
      SN1_{semantic}}, {″name” : “repo2”, “score” : SN2_{semantic} }... ]
}
```

The output from the Repository Name Search for keyword query type will look like:

```
{
      “name_match_list_keyword” : [{“name”: “repo1”, “score” :
      SN1_{keyword}}, {“name” : “repo2”, “score” : SN2_{keyword} }... ]
}
```

In some embodiments, in step 306, a search similarity score is provided against ReadMe files. The step 306 provides a search similarity match against readme text which will be retrieved from sources such as Github, Gitlab, etc. The Readme Files Search Service 110 will accept both semantic types of queries as well as keyword type of query based on the output of Query Type Detector 403. If the query is semantic, a semantic weight (W_{semantic}) determined in step 304 will be multiplied by the weight of source system (W_{source}) determined in step 304 and is further multiplied by the similarity score of match against readme text for each record in a Readme Data Source stored in File Storage 114. Similarly, if the query is for a keyword, a keyword weight (W_{keyword}) determined in step 304 will be multiplied by the weight of source system (W_{source}) determined in step 304 and it is further multiplied by the similarity score (Sₛᵢₘ) of match against readme text for each records in the Readme Data Source. For example, if SR_{semantic} denotes semantic search score for a readme text match in the data source, the calculation will be:

SR_{semantic}=W_{semantic}×W_{source}×Sₛᵢₘ

If SR_{keyword} denotes keyword search score for a readme text match in the data source, the calculation will be:

SR_{keyword}=W_{keyword}×W_{source}×Sₛᵢₘ

The output from Readme Files Search for semantic query type will look like

```
{
      “readme_match_list_semantic” : [{“name”: “repo1”, “score” :
      SR1_{semantic}}, {″name” : “repo2”, “score” : SR2_{semantic} }... ]
}
```

The output from Readme Files Search for keyword query type will look like:

```
{
      “readme_match_list_keyword” : [{“name”: “repo1”, “score” :
      SR1_{keyword}}, {″name” : “repo2”, “score” : SR2_{keyword} }... ]
}
```

In some embodiments, in step 307, a search similarity match is provided against an installation guide which will be retrieved from sources such as Github, Gitlab, Software documentation, etc. The Installation Guide Search Service 111 will accept both semantic types of queries as well as keyword types of queries based on the output of the Query Type Detector 403. If the query is semantic, a semantic weight (W_{semantic}) determined in step 304 may be multiplied by the weight of a source system (W_{source}) determined in step 304 output is further multiplied by the similarity score of match against installation guide for each records in an Installation Guide Data Source stored in the File Storage 114. Similarly, if the query is for a keyword, a keyword weight (W_{keyword}) determined in step 304 will be multiplied by a weight of source system (W_{source}) determined in step 304 output and is further multiplied by the similarity score (Sₛᵢₘ) of match against installation guide text for each records in the Installation Guide Data Source. For example, if SI_{semantic} denotes a semantic search score for an installation guide text match in the data source, the calculation will be:

SI_{semantic}=W_{semantic}×W_{source}×Sₛᵢₘ

If SI_{keyword} denotes a keyword search score for an installation guide text match in the data source, the calculation will be:

SI_{keyword}=W_{keyword}×W_{source}×Sₛᵢₘ

The output from an Installation Guide Search for semantic query type will look like:

```
{
      “install_guide_match_list_ semantic” : [{“name”: “guide1”,
      “score” : SI1_{semantic}}, {″name” : “guide2”, “score” : SI2_{semantic} }... ]
}
```

The output from an Installation Guide Search for keyword query type will look like

```
{
      “install_guide_match_list_keyword” : [{“name”: “guide1”,
      “score” : SI1_{keyword}}, {″name” : “guide2”, “score” : SI2_{keyword} }... ]
}
```

In some embodiments, in step 308, a search similarity match is provided against a source code documentation, which will be retrieved from sources such as Github, Gitlab, Software documentation, API documentation, etc. The Source Code Search Service 108 will accept both semantic types of queries as well as keyword types of queries based on the output of the Query type detector 403. If the query is semantic, a semantic weight (W_{semantic}) determined in step 304 will be multiplied by a weight of source system (W_{source}) determined in step 304 and is further multiplied by the similarity score of match against source code documentation for each records in the Source Code Data Source stored in File Storage 114. Similarly, if the query is for a keyword, a keyword weight (W_{keyword}) determined in step 304 will be multiplied by a weight of source system (W_{source}) determined in step 304 and is further multiplied by a similarity score (Sₛᵢₘ) of match against source code documentation for each records in the Source Code Data Source. For example, if SC_{semantic} denotes a semantic search score for a source code documentation match in the data source, the calculation will be:

SC_{semantic}=W_{semantic}×W_{source}×Sₛᵢₘ

If SC_{keyword} denotes a keyword search score for a source code documentation match in the data source, the calculation will be:

SC_{keyword}=W_{keyword}×W_{source}×Sₛᵢₘ

The output from Source Code Search for a semantic query type will look like

```
{
      “code_match_list_keyword” : [{“name”: “code1”, “score” :
      SC1_{semantic}}, {″name” : “code2”, “score” : SC2_{semantic} }... ]
}
```

The output from Source Code Search for a keyword query type will look like:

```
{
      “code_match_list_semantic” : [{“name”: “code1”, “score” :
      SC1_{keyword}}, {″name” : “code2”, “score” : SC2_{keyword} }... ]
}
```

In some embodiments, in step 309, a search similarity match is provided against a description, which will be retrieved from sources such as Github, Gitlab, etc. The Description Text Search Service 111 will accept both semantic types of queries as well as keyword types of queries based on the output of the Query type detector 403. If the query is semantic, a semantic weight (W_{semantic}) from step 304 will be multiplied by a weight of source system (W_{source}) determined in step 304 and is further multiplied by a similarity score of match against description text for each records in the Description Data Source stored in File Storage 114. Similarly, if the query is for a keyword, a keyword weight (W_{keyword}) determined in step 304 will be multiplied by a weight of source system (W_{source}) determined in step 304 and is further multiplied by a similarity score (Sₛᵢₘ) of match against description text for each records in the Description Data Source. For example, if SD_{semantic} denotes a semantic search score for a description text match in the data source, the calculation will be:

SD_{semantic}=W_{semantic}×W_{source}×Sₛᵢₘ

If SD_{keyword} denotes a keyword search score for a description text match in the data source, the calculation will be:

SD_{keyword}=W_{keyword}×W_{source}×Sₛᵢₘ

The output from Description Text Search for a semantic query type will look like:

```
{
      “description_match_list_semantic” : [{“name”: “repo1”, “score” :
      SD1_{semantic}}, {″name” : “repo2”, “score” : SD2_{semantic} }... ]
}
```

The output from Description Text Search for a keyword query type will look like:

```
{
      “description_match_list_keyword” : [{“name” : “repo1”, “score” :
      SD1_{keyword}}, {″name” : “repo2”, “score” : SD2_{keyword} }... ]
}
```

In some embodiments, in step 310, a search similarity match is provided against user guide text, which will be retrieved from sources such as Github, Gitlab, software documentations, articles, etc. The User Guide Search Service 112 will accept both semantic types of queries as well as keyword types of queries based on the output of the Query Type Detector 403. If the query is semantic, a semantic weight (W_{semantic}) determined in step 304 will be multiplied by a weight of source system (W_{source}) determined in step 304 and is further multiplied by a similarity score of match against user guide text for each records in the User Guide Data Source stored in File Storage 114. Similarly, if the query is for a keyword, a keyword weight (W_{keyword}) determined in step 304 will be multiplied by the weight of source system (W_{source}) determined in step 304 and is further multiplied by a similarity score (Sₛᵢₘ) of match against user guide text for each records in the User Guide Data Source. For example, if SU_{semantic} denotes a semantic search score for a user guide text match in the data source, the calculation will be:

SU_{semantic}=W_{semantic}×W_{source}×Sₛᵢₘ

If SU_{keyword} denotes a keyword search score for a user guide text match in the data source, the calculation will be:

SU_{keyword}=W_{keyword}×W_{source}×Sₛᵢₘ

The output from the User Guide Search Service 112 for a semantic query type will look like:

```
{
      “user_guide_match_list_semantic” : [{“name”: “userguide1”,
      “score” : SU1_{semantic}}, {″name” : “userguide2”, “score” : SU2_{semantic}
      }... ]
}
```

The output from the User Guide Search Service 112 for a keyword query type will look like:

```
{
      “user_guide_match_list_keyword” : [{“name”: “userguide1”,
      “score” : SU1_{keyword}}, {″name” : “userguide2”, “score” : SU2_{keyword}
      }... ]
}
```

In some embodiments, in step 311, the individual responses (e.g., response fields) from each step 305, 306, 307, 308, 309 and 310 are stored into a Common Temporary Data Structure stored in the File Storage 114 as provided below. While the example below is described in regards to the response determined in step 305 (e.g., search similarity matches against a repository name), the present example may be similarly applied to some or all of the remaining source response fields.

```
{
  “name_match_list_semantic” : [{“name”: “repo1”, “score” :
  SN1_{semantic}}, {″name” : “repo2”, “score” : SN2_{semantic} }... ],
  “name_match_list_keyword” : [{“name”: “repo1”, “score” : SN1_{keyword}},
  {“name” : “repo2”, “score” : SN2_{keyword} }... ],
  “readme_match_list_semantic” : [{“name”: “repo1”, “score” :
  SR1_{semantic}}, {″name” : “repo2”, “score” : SR2_{semantic} }... ],
  “readme_match_list_keyword” : [{“name”: “repo1”, “score” :
  SR1_{keyword}}, {″name” : “repo2”, “score” : SR2_{keyword} }... ],
  “install_guide_match_list_semantic” : [{“name”: “guide1”, “score” :
  SI1_{semantic}}, {″name” : “guide2”, “score” : SI2_{semantic} }... ],
  “install_guide_match_list_keyword” : [{“name”: “guide1”, “score” :
  SI1_{keyword}}, {″name” : “guide2”, “score” : SI2_{keyword} }... ],
  “code_match_list_keyword” : [{“name”: “code1”, “score” : SC1_{semantic}},
  {″name” : “code2”, “score” : SC2_{semantic} }... ],
  “code_match_list_semantic” : [{“name”: “code1”, “score” : SC1_{keyword}},
  {″name” : “code2”, “score” : SC2_{keyword} }... ],
  “description_match_list_semantic” : [{“name”: “repo1”, “score” :
  SD1_{semantic}}, {″name” : “repo2”, “score” : SD2_{semantic} }... ],
  “description_match_list_keyword” : [{“name”: “repo1”, “score” :
  SD1_{keyword}}, {″name” : “repo2”, “score” : SD2_{keyword} }... ],
  “user_guide_match_list_semantic” : [{“name”: “userguide1”, “score” :
  SU1_{semantic}}, {″name” : “userguide2”, “score” : SU2_{semantic} }... ],
  “user_guide_match_list_keyword” : [{“name”: “userguide1”, “score” :
  SU1_{keyword}}, {″name” : “userguide2”, “score” : SU2_{keyword} }... ]
}
```

In some embodiments, in step 312, the process step Generate Combined Match Score 312 in FIG. 3 will combine the weight of step 303 with score of step 311. The output from Field weight assigner 502 of process step 303 will be:

```
{
      “query” : “connecting to mysql using spring boot”,
      “description weight” : 1.0,
      “name_weight” : 0.5,
      “code_weight” : 0.5,
      “install_weight” : 0.5,
      “readme_weight” : 0.5,
      “user_guide_weight” : 0.5
}
```

Each of the weights from the above output will be multiplied with each of the item from the respective source response list. For example, the weight of description (description_weight) from Field weight assigner 502 will be multiplied with each item score from the list of “description_match_list_semantic” field of 311 as follows:

“description_match_list_semantic_combined”: [{“name”: “repo1”, “score”: SD1_{semantic}×description_weight}, {“name”: “repo2”, “score”: SD2_{semantic}×description_weight} . . . ]

A similar calculation can be performed for the keyword field as follows:

“description_match_list_keyword_combined”: [{“name”: “repo1”, “score”: SD1_{keyword}×description_weight}, {“name”: “repo2”, “score”: SD2_{keyword}×description_weight} . . . ]

Similar calculations may happen for all the source search response fields which are identified in step 304. Finally, the response from all the source fields will be combined and sorted in descending order by the combined score calculated and send to step 313.

What is claimed is:

1. A system for retrieving and automatically ranking software component search results, the system comprising:
one or more processors and memory storing instructions that, when executed by the one or more processors, cause the one or more processors to perform operations comprising:
parsing a search query to extract a plurality of search entities;
assigning each of the plurality of search entities a weight value;
identifying a plurality of software component sources based on the search entities;
searching the software component sources for a plurality of software components;
retrieving a plurality of software components;
comparing each of the plurality of software components with each of the plurality of search entities and generating a plurality of similarity scores based on each comparison;
generating a plurality of match scores by proportionally combining each of the plurality of similarity scores with a weight value;
mapping the plurality of match scores to the plurality of software components;
generating a combined match score for each of the software components by combining one or more mapped match scores associated with each of the plurality of software components; and
generating a ranking of the software components based on the combined match scores.

2. The system of claim 1, wherein the plurality of software component sources comprise at least one of repository name files, source code files, description text files, ReadMe files, installation guide files, or user guide files.

3. The system of claim 1, the operations further comprising accepting a remote location of the search query via a first web GUI portal that allows a user to upload a request comprising the search query.

4. The system of claim 1, the operations further comprising:
compiling a software data set;
extracting software category data;
preparing training data from the software category data; and
training a machine learning model via the training data to identify the plurality of one or more software component sources based on the search entities.

5. The system of claim 1, the operations further comprising:
providing each search entity to a search system of a plurality of search systems, each search system individually configured to access and search one of the plurality of software component sources, wherein retrieving the plurality of software components comprises receiving the plurality of software components from the plurality of search systems.

6. The system of claim 5, wherein each of the plurality of search systems utilizes a separate machine-learning model, the separate machine learning model trained via training data specific to a software category source.

7. The system of claim 1, wherein assigning each of the plurality of search entities a weight value comprises:
compiling a plurality of previous search queries;
extracting data by reading the previous search queries for keywords and semantic linguistics
preparing training data based on the extracted data
training a machine-learning model via the training data to infer a relative level of importance associated with an intent of the search query user for each of the search entities; and
applying the machine-learning model to the plurality of search entities to determine a relative weight value for each of the plurality of search entities.

8. The system of claim 1, the operations further comprising:
identifying a threshold weighted value score; and
discarding one or more search entities assigned a weighted value less than the threshold weighted value from the plurality of search entities, prior to identifying the plurality of software component sources based on the search entities.

9. A method for retrieving and automatically ranking software component search results, the method comprising:
parsing a search query to extract a plurality of search entities;
assigning each of the plurality of search entities a weight value;
identifying a plurality of software component sources based on the search entities;
searching the software component sources for a plurality of software components;
retrieving a plurality of software components;
comparing each of the plurality of software components with each of the plurality of search entities and generating a plurality of similarity scores based on each comparison;
generating a plurality of match scores by proportionally combining each of the plurality of similarity scores with a weight value;
mapping the plurality of match scores to the plurality of software components;
generating a combined match score for each of the software components by combining one or more mapped match scores associated with each of the plurality of software components; and
generating a ranking of the software components based on the combined match scores.

10. The method of claim 9, wherein the plurality of software component sources comprise at least one of repository name files, source code files, description text files, ReadMe files, installation guide files, or user guide files.

11. The method of claim 9, the further comprising accepting a remote location of the search query via a web GUI portal that allows a user to upload a request comprising the search query.

12. The method of claim 9, further comprising:
compiling a software data set by searching public software sources;
extracting software category data;
preparing training data from the software category data; and
training a machine learning model via the training data to identify the plurality of one or more software component sources based on the search entities.

13. The method of claim 9, further comprising:
providing each search entity to a search system of a plurality of search systems, each search system individually configured to access and search one of the plurality of software component sources, wherein retrieving the plurality of software components comprises receiving the plurality of software components from the plurality of search systems.

14. The method of claim 13, wherein each of the plurality of search systems utilizes a separate machine-learning model, the separate machine learning model trained via training data specific to a software category source.

15. The method of claim 9, wherein assigning each of the plurality of search entities a weight value comprises:
compiling a plurality of previous search queries;
extracting data by reading the previous search queries for keywords and semantic linguistics
preparing training data based on the extracted data
training a machine-learning model via the training data to infer a relative level of importance associated with an intent of the search query user for each of the search entities; and
applying the machine-learning model to the plurality of search entities to determine a relative weight value for each of the plurality of search entities.

16. The method of claim 9, further comprising:
identifying a threshold weighted value score; and
discarding one or more search entities assigned a weighted value less than the threshold weighted value from the plurality of search entities, prior identifying the plurality of software component sources based on the search entities.

17. A computer program product for retrieving and automatically ranking software component search results, comprising a processor and memory storing instructions thereon, wherein the instructions when executed by the processor cause the processor to:
parse a search query to extract a plurality of search entities;
assign each of the plurality of search entities a weight value;
identify a plurality of software component sources based on the search entities;
search the software component sources for a plurality of software components;
retrieve a plurality of software components;
compare each of the plurality of software components with each of the plurality of search entities and generating a plurality of similarity scores based on each comparison;
generate a plurality of match scores by proportionally combining each of the plurality of similarity scores with a weight value;
map the plurality of match scores to the plurality of software components;
generate a combined match score for each of the software components by combining the one or more mapped match scores associated with each of the plurality of software components; and
generate a ranking of the software components based on the combined match scores.

18. The computer program product of claim 17, wherein the instructions further cause the processor to:
compile a software data set by searching public software sources;
extract software category data;
prepare training data from the software category data; and
train a machine learning model via the training data to identify the plurality of one or more software component sources based on the search entities;

19. The computer program product of claim 17, wherein the instructions further cause the processor to:
provide each search entity to a search system of a plurality of search systems, each search system individually configured to access and search one of the plurality of software component sources,
wherein retrieving the plurality of software components comprises receiving the plurality of software components from the plurality of search systems,
wherein each of the plurality of search systems utilizes a separate machine-learning model, the separate machine learning model trained via training data specific to a software category source.

20. The computer program product of claim 17, wherein assigning each of the plurality of search entities a weight value comprises:
compiling a plurality of previous search queries;
extracting data by reading the previous search queries for keywords and semantic linguistics
preparing training data based on the extracted data;
training a machine-learning model via the training data to infer a relative level of importance associated with an intent of the search query user for each of the search entities; and
applying the machine-learning model to the plurality of search entities to determine a relative weight value for each of the plurality of search entities.
